(19) United States
(12) Patent Application Publication
(10) Pub. No.: US 2008/0120208 A1
(43) Pub. Date: May 22, 2008

(54) SYSTEM AND METHOD FOR RECEIVING AND CHANGING A BILL OF MATERIAL FOR VEHICLE COMPONENTS

(75) Inventor: Gahl Berkooz, Ann Arbor, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD MOTOR COMPANY, Dearborn, MI (US)

(21) Appl. No.: 11/554,132

(22) Filed: Oct. 30, 2006

(51) Int. Cl. G06F 17/50

(52) U.S. Cl. 705/29

(57) ABSTRACT

In at least one embodiment, first data from a first functional group is received describing an attribute of a first component of a bill of material, second data from a second functional group is received describing the attribute of the first component, and the first data and the second data are permitted to be inconsistent for a predefined duration.

### BACKGROUND OF THE INVENTION

1. Field of the Invention

The invention relates to systems and methods for receiving and changing a bill of material for vehicle components.

2. Background

Different functional groups, e.g., Engineering and Finance, within an organization may change and track data within respective bills of material differently. For example, Finance may need to track cost data on a weekly basis, thus making changes to the cost field of Finance's bill of material weekly. Engineering may need to track cost data on a monthly basis, thus making changes to the cost field of Engineering's bill of material monthly.

Different functional groups may not simultaneously need the same types of data within their respective bills of material. For example, during initial phases of product development, Finance may not need component weight data, whereas Engineering may require it.

Once certain development milestones have passed, different functional groups may be required to have consistent bills of material. For example, twelve months before a vehicle goes into production, cost data from Finance and Engineering may need to be consistent to prevent uncertainty about the cost of the vehicle.

Under circumstances where different functional groups each maintain their own bill of material, the process of tracking changes and making them consistent can be time consuming and subject to error.

A system and method are desired that, for a single bill of material, permit data to be inconsistent during a first time period and require at least a portion of the data to be consistent during a second time period.

### SUMMARY

In at least one embodiment, the invention takes the form of a computer-implemented system for receiving and changing a bill of material for vehicle components. The system includes a computer program configured to direct one or more computers to, during a first time period, receive first data from a first functional group describing a first component of the bill of material, receive second data from a second functional group describing the first component, and permit the first data and the second data to be inconsistent. The computer program is further configured to direct one or more computers to, during a subsequent second time period, require at least a portion of the first data and the second data to be consistent.

In at least one embodiment, the invention takes the form of a method for receiving and changing a bill of material for vehicle components. The method includes, during a first time period, receiving first data from a first functional group describing a first component of the bill of material, receiving second data from a second functional group describing the first component, and permitting the first data and the second data to be inconsistent. The method also includes, during a subsequent second time period, requiring at least a portion of the first data and the second data to be consistent.

In at least one embodiment, the invention takes the form of a method for receiving and changing a bill of material for vehicle components. The method includes receiving first data from a first functional group describing an attribute of a first component of the bill of material, receiving second data from a second functional group describing the attribute of the first component, and permitting the first data and the second data to be inconsistent for a predefined duration.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 shows a computer-implemented system for receiving and changing a bill of material for vehicle components in accordance with an embodiment of the invention.

FIG. 2 shows a bill of material over time in accordance with an embodiment of the invention.

FIG. 3 shows a bill of material in accordance with an embodiment of the invention.

FIGS. 4a and 4b show a method for receiving and changing a bill of material for vehicle components in accordance with an embodiment of the invention.

FIG. 5 shows a method for receiving and changing a bill of material for vehicle components in accordance with an embodiment of the invention.

### DETAILED DESCRIPTION

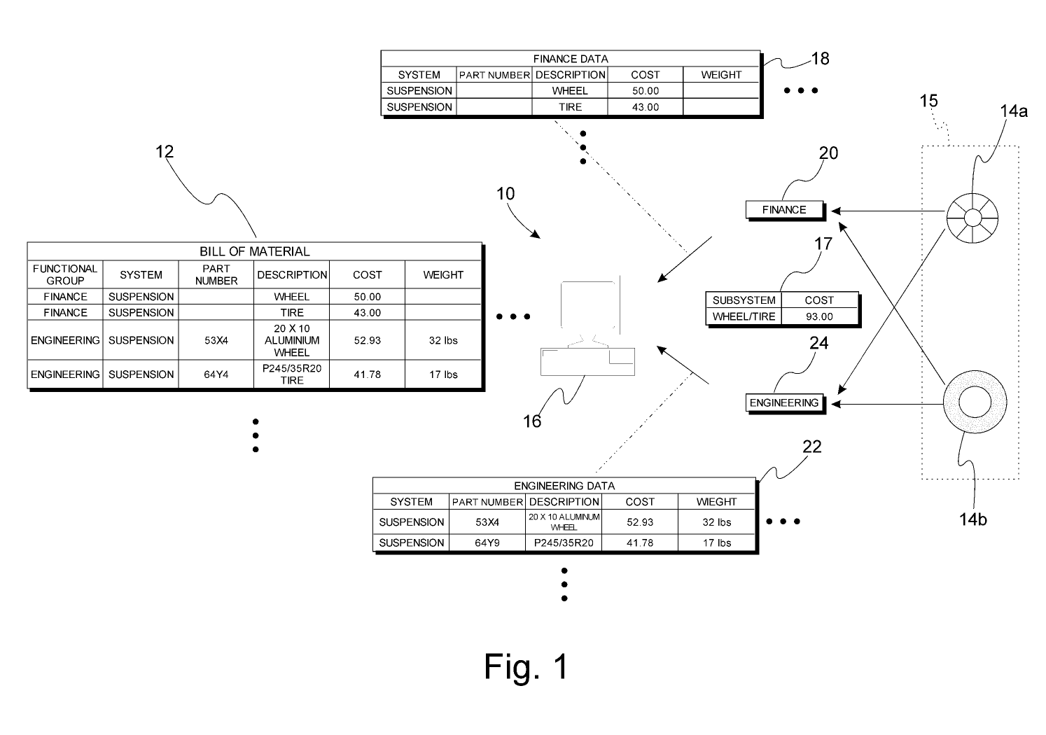

FIG. 1 shows a system 10 for receiving and changing a bill of material (BOM) 12 for vehicle components 14a-14n, e.g., wheel 14a and tire 14b. Wheel 14a and tire 14b comprise wheel/tire subsystem 15. System 10 includes computer 16 programmed to receive data 18 from a functional group 20, e.g., Finance, and receive data 22 from another functional group 24, e.g., Engineering. Computer 16 may further receive subsystem data 17 describing a subsystem, e.g., wheel/tire subsystem 15, as will be explained in detail below.

Data 18, 22 describe vehicle components 14a-14n, e.g., wheel 14a and tire 14b, in terms of “SYSTEM,” “PART NUMBER,” “DESCRIPTION,” “COST,” and “WEIGHT.” Data 18, 22 may describe vehicle components 14a-14n in fewer, different, or other terms. Data 18, 22 populate the appropriate fields of BOM 12.

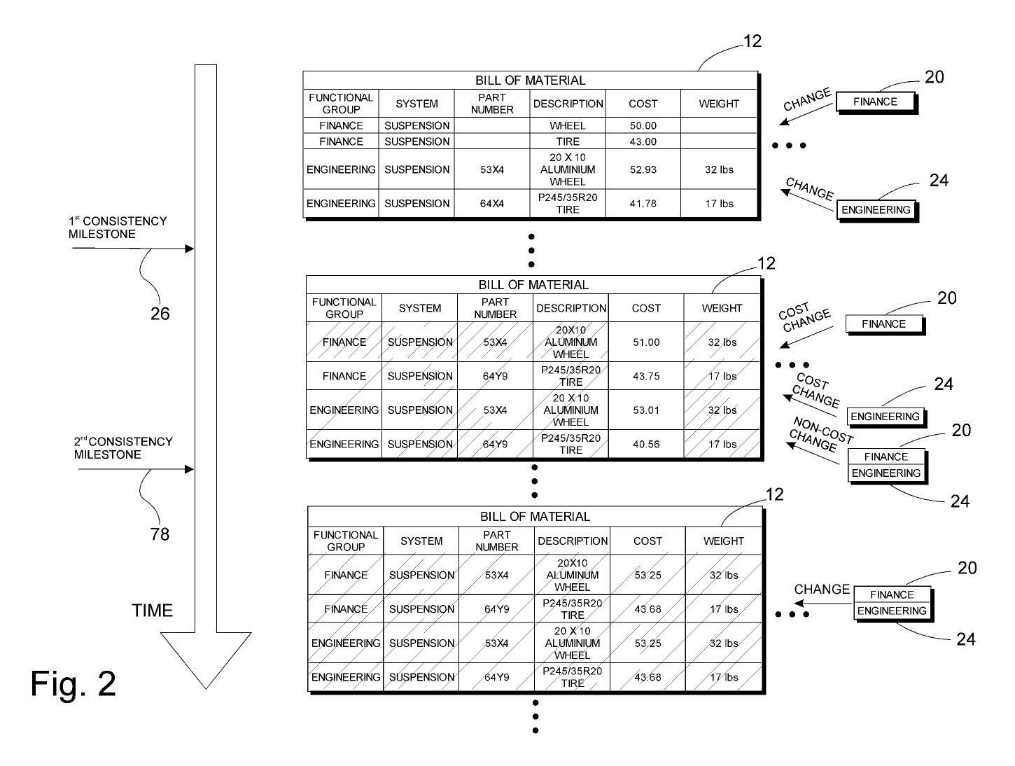

FIG. 2 shows BOM 12 over time. Before first consistency milestone 26, all data 18, 22 within BOM 12 may be inconsistent. For example, cost for wheel 14a, according to Finance, is $50.00 and, according to Engineering, is $52.93. Further, Engineering has weight information for wheel 14a and tire 14b, e.g., 32 lbs. and 17 lbs., whereas Finance lacks weight information for wheel 14a and tire 14b. Before first consistency milestone 26, either functional group 20, 24 may independently change their respective data 18, 22 in BOM 12. For example, Engineering may change the cost of wheel 14a from $52.93 to $65.00 without notifying or seeking permission from Finance.

After first consistency milestone 26 but before second consistency milestone 28, a portion of data 18, 22 within BOM 12 is required to be consistent. For example, the data 18, 22 that appear in the textured fields “FUNCTIONAL GROUP,” “SYSTEM,” “PART NUMBER,” “DESCRIPTION,” and “WEIGHT” are required to be the same for Engineering and Finance. Alternatively, BOM 12 may be constructed such that a portion of data 18, 22 required to be consistent may be collapsed, using any suitable technique, to a single field. For example, Finance and Engineering may each have a field for “COST” but share fields for “FUNCTIONAL GROUP,” “SYSTEM,” “PART NUMBER,” “DESCRIPTION,” and “WEIGHT.”

After first consistency milestone 26 but before second consistency milestone 28, system 10 prevents either functional group 20, 24 from independently changing that data required to be consistent but permits either functional group 20, 24 to independently change that data not required to be consistent. For example, Finance and Engineering may independently change their cost data. Finance and Engineering, however, must make coordinated changes to non-cost data. This coordinated change may take the form of permission from each functional group 20, 24 such that when permission is granted, a change to one of data 18, 22 executes the same change to the other of data 18, 22. For example, if Engineering changes the part number for wheel 14a from “53×4” to “53×5,” system 10 will change Finance's part number for wheel 14a from “53×4” to “53×5.”

After second consistency milestone 28, all data 18, 22 within BOM is required to be consistent. The functional groups 20, 24 may only make coordinated changes to BOM 12.

System 10 may track changes to BOM 12 over time. For example, a version of BOM 12 may be saved if a change is made. System 10 may then be prompted to recall a prior version of BOM 12 in an effort to understand a change history of BOM 12.

System 10 may permit functional group 20 to access data 22 of functional group 24 and vice versa. This access may vary depending upon consistency milestones 26, 28. For example, before first consistency milestone 26, Engineering may not access Finance's data 18 within BOM 12 whereas after first consistency milestone 22, Engineering may access at least a portion of Finance's data 18.

As explained above, computer 16 may receive subsystem data 17 describing a subsystem. For example, during an initial phase of product development, Finance may track cost at the subsystem level, e.g., wheel/tire subsystem 15, instead of at the component level, e.g., wheel 14a and tire 14b. As such, Finance may submit cost data 17 (FIG. 1) only for subsystems, e.g., wheel/tire subsystem 15.

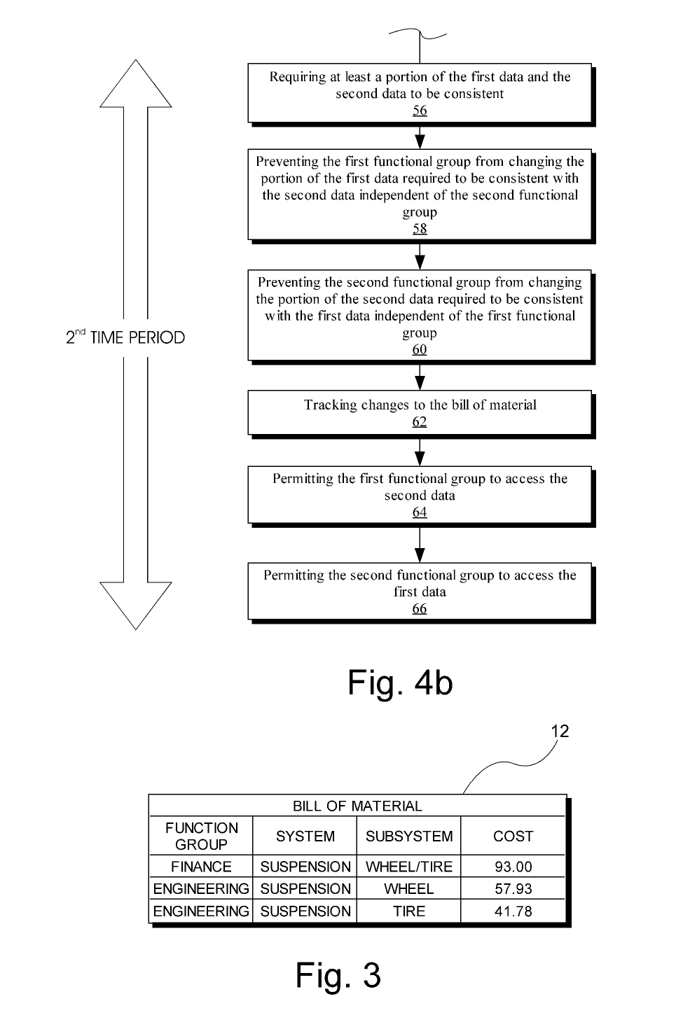

FIG. 3 shows an example portion of BOM 12 under such circumstances before first consistency milestone 26. System 10 may check the consistency of a portion of any such subsystem data 17 against data 18, 22. For example, FIG. 3 shows that Finance has a cost of $93.00 for wheel/tire subsystem 15 and the Engineering has a cost of $52.93 for wheel 14a and $41.78 for tire 14b. System 10 may compare the sum of Engineering's costs for wheel 14a and tire 14b to Finance's costs of $93.00 and determine that they are inconsistent. According to the example's above, this type of condition would not be permitted after second consistency milestone 78.

In the examples above, BOM 12 is shown in tabular format with each functional group 20, 24 having a respective row of data for each component 14a-14n. BOM 12 need not be in tabular format. BOM 12 can take any desired form.

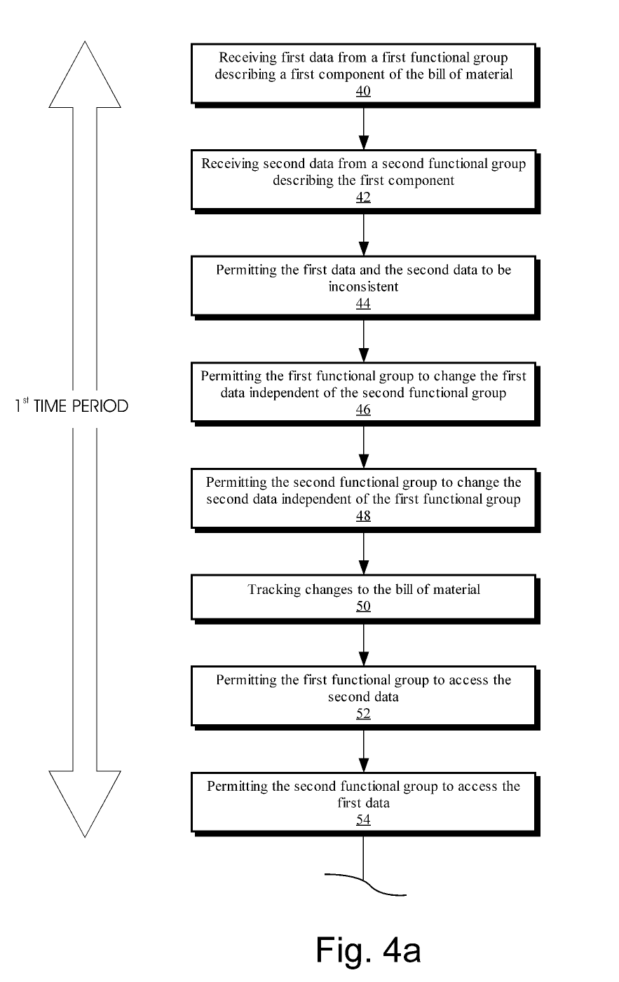

FIGS. 4a and 4b show a method for receiving and changing a bill of material for vehicle components. During a first time period: at 40, first data is received from a first functional group describing a first component of the bill of material; at 42, second data is received from a second functional group describing the first component; at 44, the first data and the second data are permitted to be inconsistent; at 46, the first functional group is permitted to change the first data independent of the second functional group; at 48, the second functional is permitted to change the second data independent of the first functional group; at 50, changes to the bill of material are tracked; at 52, the first functional group is permitted to access the second data; at 54, the second functional group is permitted to access the first data.

During a subsequent second time period: at 56, at least a portion of the first data and the second data are required to be consistent; at 58, the first functional group is prevented from changing the portion of the first data required to be consistent with the second data independent of the second functional group; at 60, the second functional group is prevented from changing the portion of the second data required to be consistent with the first data independent of the first functional group; at 62, changes to the bill of material are tracked; at 64, the first functional group is permitted to access the second data; at 66, the second functional group is permitted to access the first data.

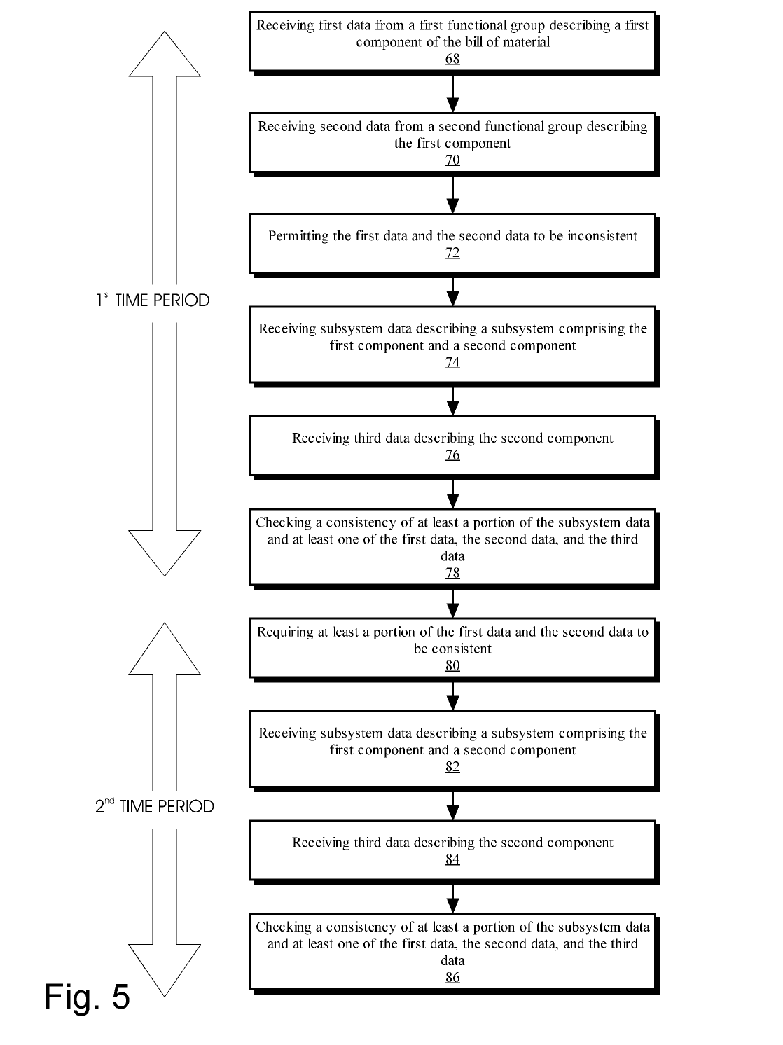

FIG. 5 shows a method for receiving and changing a bill of material for vehicle components. During a first time period: at 68, first data is received from a first functional group describing a first component of the bill of material; at 70, second data is received from a second functional group describing the first component; at 72, the first data and the second data are permitted to be inconsistent; at 74, subsystem data is received describing a subsystem comprising the first component and a second component, at 76, third data is received describing the second component, at 78, a consistency of at least a portion of the subsystem data and at least one of the first data, the second data, and the third data is checked.

During a subsequent second time period: at 80, at least a portion of the first data and the second data are required to be consistent; at 82, subsystem data is received describing a subsystem comprising the first component and a second component, at 84, third data is received describing the second component, at 86, a consistency of at least a portion of the subsystem data and at least one of the first data, the second data, and the third data is checked.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A computer-implemented system for receiving and changing a bill of material for vehicle components comprising:
a computer program configured to direct one or more computers to,
during a first time period,
receive first data from a first functional group describing a first component of the bill of material,
receive second data from a second functional group describing the first component, and
permit the first data and the second data to be inconsistent, and
during a subsequent second time period,
require at least a portion of the first data and the second data to be consistent.

2. The system of claim 1 wherein the computer is further configured to track changes to the bill of material.

3. The system of claim 1 wherein the computer is further configured to permit the first functional group to access the second data.

4. The system of claim 1 wherein the computer is further configured to permit the second functional group to access the first data.

5. The system of claim 1 wherein the computer is further configured to, during the first time period, permit the first functional group to change the first data independent of the second functional group.

6. The system of claim 1 wherein the computer is further configured to, during the first time period, permit the second functional group to change the second data independent of the first functional group.

7. The system of claim 1 wherein the computer is further configured to, during the second time period, prevent the first functional group from changing the portion of the first data required to be consistent with the second data independent of the second functional group.

8. The system of claim 1 wherein the computer is further configured to, during the second time period, prevent the second functional group from changing the portion of the second data required to be consistent with the first data independent of the first functional group.

9. The system of claim 1 wherein the computer is further configured to receive subsystem data describing a subsystem comprising the first component and a second component, receive third data describing the second component, and check a consistency of at least a portion of the subsystem data and at least one of the first data, the second data, and the third data.

10. A method for receiving and changing a bill of material for vehicle components comprising:
during a first time period,
receiving first data from a first functional group describing a first component of the bill of material,
receiving second data from a second functional group describing the first component, and
permitting the first data and the second data to be inconsistent; and
during a subsequent second time period,
requiring at least a portion of the first data and the second data to be consistent.

11. The method of claim 10 further comprising tracking changes to the bill of material.

12. The method of claim 10 further comprising permitting the first functional group to access the second data.

13. The method of claim 10 further comprising permitting the second functional group to access the first data.

14. The method of claim 10 further comprising permitting the first functional group to change the first data independent of the second functional group during the first time period.

15. The method of claim 10 further comprising permitting the second functional group to change the second data independent of the first functional group during the first time period.

16. The method of claim 10 further comprising preventing the first functional group from changing the portion of the first data required to be consistent with the second data independent of the second functional group during the second time period.

17. The method of claim 10 further comprising preventing the second functional group from changing the portion of the second data required to be consistent with the first data independent of the first functional group during the second time period.

18. The method of claim 10 further comprising receiving subsystem data describing a subsystem comprising the first component and a second component, receiving third data describing the second component, and checking a consistency of at least a portion of the subsystem data and at least one of the first data, the second data, and the third data.

19. A method for receiving and changing a bill of material for vehicle components comprising:
receiving first data from a first functional group describing an attribute of a first component of the bill of material,
receiving second data from a second functional group describing the attribute of the first component, and
permitting the first data and the second data to be inconsistent for a predefined duration.

20. The method of claim 19 further comprising requiring at least a portion of the first data and the second data to be consistent after the predefined duration.
